(19) United States
(12) Patent Application Publication
(10) Pub. No.: US 2012/0281338 A1
(43) Pub. Date: Nov. 8, 2012

(54) ALUMINUM ELECTROLYTIC CAPACITOR AND METHOD OF MANFACTURING THE SAME

(75) Inventors: WEI CHIH LEE, NEW TAIPEI CITY (TW); SHIH KWAN LIU, HSINCHU CITY (TW)

(73) Assignee: INPAQ TECHNOLOGY CO., LTD., MIAOLI (TW)

(21) Appl. No.: 13/101,406

(22) Filed: May 5, 2011

(51) Int. Cl. H01G 9/15

(52) U.S. Cl. 361/524; 361/523

(57) ABSTRACT

An aluminum electrolytic capacitor includes an aluminum foil substrate, a porous aluminum layer, an insulating layer, an electrically conductive polymer material, an electrically conductive material, and at least two terminal electrodes. The porous aluminum layer is attached to the aluminum foil substrate. The insulating layer is formed on the porous aluminum layer. The electrically conductive polymer material overlays the insulating layer. The terminal electrodes respectively connect to the aluminum foil and the electrically conductive material.

### BACKGROUND OF THE INVENTION

1. Field of the Invention

The present invention relates to an aluminum electrolytic capacitor and a method of manufacturing the same, and relates more particularly to an SMD-type aluminum electrolytic capacitor and a method of manufacturing the same.

2. Description of the Related Art

In recent years, electronic mobile apparatuses, designed for smaller size and greater speed, need to have capacitors exhibiting better high frequency performance, smaller size, larger capacitance and lower resistance. Current multi-layer ceramic capacitors (MLCC), the most common type of capacitors used in mobile apparatuses, appear unable to continue meeting the increasingly-challenging above requirements. Therefore, the development of new capacitor designs must be accelerated to keep pace with the requirements of newly-developed electronic mobile apparatuses.

Conventional solid electrolytic capacitors mainly include metal such as aluminum, tantalum, niobium, or titanium, of which aluminum and tantalum are most commonly used to manufacture solid aluminum electrolytic capacitors or solid tantalum electrolytic capacitors.

The dielectric layer in an aluminum electrolytic capacitor is normally a metal oxide (aluminum oxide) layer on a surface of a porous aluminum plate. However, such a configuration has a limited ability to increase the area of the dielectric layer. U.S. Pat. No. 6,775,127 discloses using a tantalum or niobium foil as the substrate of a solid capacitor. Tantalum or niobium powder is coated on the foil, and is then sintered to obtain a porous dielectric structure, which can provide a larger area for forming a metal oxide film, the dielectric layer. However, the process requires temperatures as high as 1600 degrees Celsius. If the processing temperature can be lowered and a structure combining the porous metal foil and the porous metal block is adopted, the capacitor can be manufactured to have a higher capacitance.

Current SMD-type solid capacitors use lead frames to connect external printed circuit boards, as disclosed in U.S. Pat. No. 6,249,424 and Taiwan Utility Model Patent No. M320738. However, the contacts between the lead frame and the solid capacitor in the disclosed solid capacitor introduce interface resistances, which combine with the resistance of the lead frame, increasing equivalent series resistance (ESR) of the solid capacitor. If the solid capacitor can be improved by removing the lead frame, the ESR can be minimized and its manufacturing cost can be reduced.

### SUMMARY OF THE INVENTION

The present invention provides an aluminum electrolytic capacitor that can be easily manufactured with high capacitance and low ESR, and a method of manufacturing the same. The manufacturing method comprises sintering aluminum powder, securely attaching the sintered aluminum powder to an aluminum foil substrate, and forming a large area of oxide dielectric layer on the aluminum powder particles and a surface of the aluminum foil substrate, thereby increasing the capacitance.

The present invention provides an aluminum electrolytic capacitor without using a lead frame. Such aluminum electrolytic capacitor can have low interface resistance, low transmission impedance and low ESR, and offers superior high-frequency performance.

The present invention provides an aluminum electrolytic capacitor, which includes capacitor units that can easily stack on each other and connect in parallel with each other. Such aluminum electrolytic capacitor can have improved capacitance and low ESR.

In summary, the present invention discloses an aluminum electrolytic capacitor including an aluminum foil substrate, a porous aluminum layer, an insulating layer, an electrically conductive polymer material, an electrically conductive material, and at least two terminal electrodes. The porous aluminum layer is attached to the aluminum foil substrate. The insulating layer is formed on the porous aluminum layer. The electrically conductive polymer material overlays the insulating layer. The electrically conductive material overlays the electrically conductive polymer material. The at least two terminal electrodes electrically connect, in a respective manner, the aluminum foil substrate and the electrically conductive material.

The invention further discloses an aluminum electrolytic capacitor including an insulating substrate, a first aluminum layer, a porous second aluminum layer, an insulating layer, an electrically conductive polymer material, an electrically conductive material, and at least two terminal electrodes. The first aluminum layer is attached to the insulating substrate. The second aluminum layer is formed on the first aluminum layer. The insulating layer is formed on the first and second aluminum layers. The electrically conductive polymer material overlays the insulating layer. The electrically conductive material overlays the electrically conductive polymer material. The at least two terminal electrodes electrically connect, in a respective manner, the first aluminum layer and the electrically conductive material.

The present invention discloses a method of manufacturing an aluminum electrolytic capacitor. The method comprises providing an aluminum foil substrate, forming a porous aluminum layer on the aluminum foil substrate, forming an oxide layer on the aluminum layer, overlaying the oxide layer with an electrically conductive polymer material, overlaying the electrically conductive polymer material with an electrically conductive material, and forming at least two terminal electrodes respectively electrically connecting the aluminum foil substrate and the electrically conductive material.

The present invention discloses another method of manufacturing an aluminum electrolytic capacitor. The method comprises providing an insulating substrate, forming a first aluminum layer on the insulating substrate, forming a porous second aluminum layer on the first aluminum layer, forming an oxide layer on the first and second aluminum layers, overlaying the insulating layer with an electrically conductive polymer material, overlaying the electrically conductive polymer material with an electrically conductive material, and forming at least two terminal electrodes respectively electrically connecting the aluminum foil substrate and the electrically conductive material.

To better understand the above-described objectives, characteristics and advantages of the present invention, embodiments, with reference to the drawings, are provided for detailed explanations.

### BRIEF DESCRIPTION OF THE DRAWINGS

The invention will be described according to the appended drawings in which:

FIG. 1A through 1E are cross-sectional views demonstrating the steps of a method of manufacturing an aluminum electrolytic capacitor according to one embodiment of the present invention;

FIG. 2 is a cross-sectional view showing an aluminum electrolytic capacitor including a stack of capacitor units according to one embodiment of the present invention;

FIG. 3 is an enlarged view of an aluminum electrolytic capacitor according to one embodiment of the present invention;

FIG. 4A through 4E are cross-sectional views demonstrating the steps of a method of manufacturing an aluminum electrolytic capacitor according to one embodiment of the present invention;

FIG. 5 is a cross-sectional view showing an aluminum electrolytic capacitor including a stack of capacitor units according to one embodiment of the present invention; and

FIG. 6 is an enlarged view of an aluminum electrolytic capacitor according to one embodiment of the present invention.

### DETAILED DESCRIPTION OF THE INVENTION

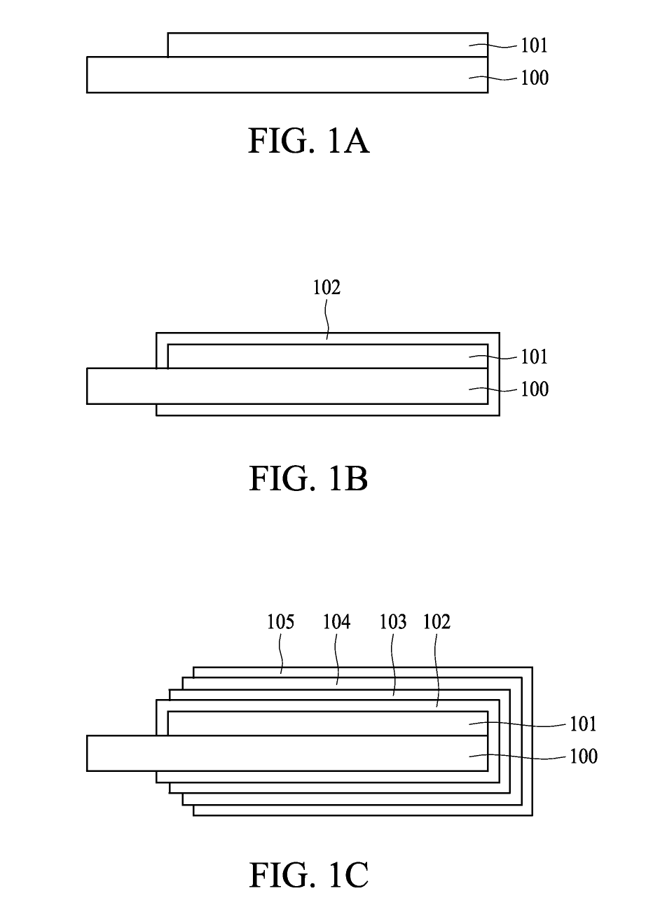

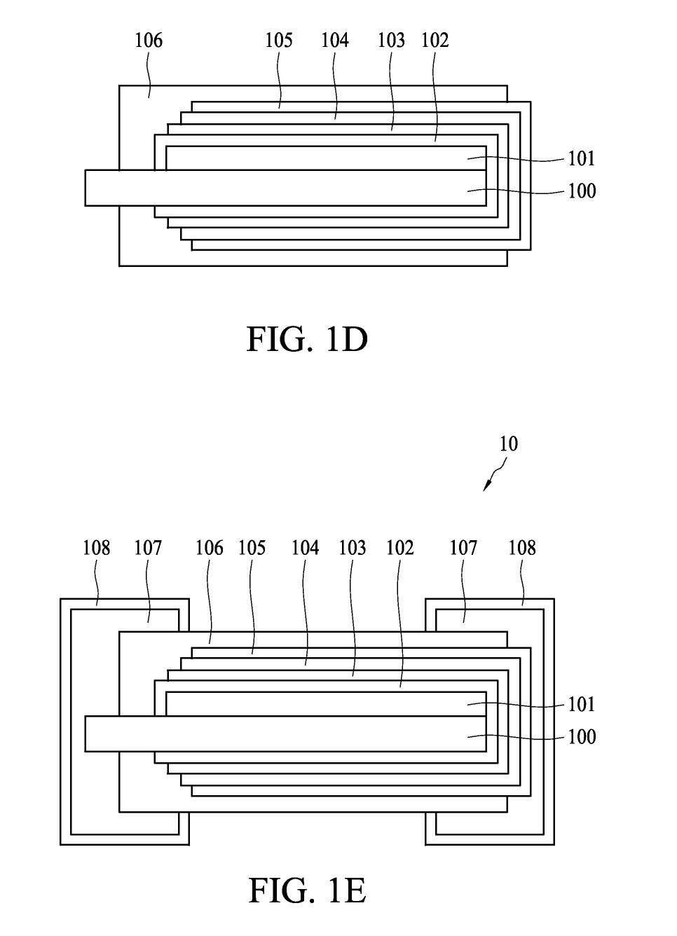

FIG. 1A through 1E are cross-sectional views demonstrating the steps of a method of manufacturing an aluminum electrolytic capacitor according to one embodiment of the present invention. As illustrated in FIG. 1A, an aluminum foil substrate 100 is provided. The aluminum foil substrate 100 can, preferably, be an etched aluminum foil having a rough surface on which a plurality of cavities or dents are formed. A layer of aluminum powder is coated on a surface of the aluminum foil substrate 100 by a printing method, and is then sintered at a temperature in a range of from 550 to 650 degrees Celsius to form a porous aluminum layer 101 securely combined and electrically connected with the aluminum foil substrate 100.

As shown in FIG. 1B, an insulating layer or a dielectric layer 102 is formed on a surface of the porous aluminum layer 101 and a surface of the aluminum foil substrate 100. In one embodiment, aluminum foil substrate 100 coated with the porous aluminum layer 101 is, preferably, placed in a solution containing phosphoric acid. An electrical current is then applied to form an aluminum oxide layer on the surface of the porous aluminum layer 101 and the surface of the aluminum foil substrate 100. Alternatively, a thermal oxidation process or the like can be employed to oxidize the aluminum on the surface to form aluminum oxide (Al₂O₃). Because the aluminum layer 101 is constituted by fine aluminum particles, pores exist between adjacent sintered-together aluminum particles. Namely, the coverage of the insulating layer 102 is not only on the surfaces of the porous aluminum layer 101 and the aluminum foil substrate 100 as shown in FIG. 1B, but also on walls defining the pores.

As shown in FIG. 1C, an electrically conductive polymer material 103, a first electrically conductive material 104, and a second electrically conductive material 105 are sequentially formed on the insulating layer 102. The electrically conductive polymer material 103 may include polyaniline, polypyrrole, or polythiophene, wherein polyaniline is preferred. For example, polyaniline can be obtained by polymerization of monomer aniline using an oxidant and a medium. The first electrically conductive material 104 can be carbon epoxy, carbon paste, or carbon ink. The second electrically conductive material 105 can be a silver paste. It can be noted that if a suitable material is chosen as the electrically conductive polymer material 103, the capacitor may not necessarily include the first electrically conductive material 104 and a second electrically conductive material 105.

As shown in FIG. 1D, a dielectric polymer material 106 is formed to overlay the surface of the second electrically conductive material 105 while a side surface of the second electrically conductive material 105 is exposed outside the dielectric polymer material 106; meanwhile, one side portion of the aluminum foil substrate 100 is also exposed outside the dielectric polymer material 106.

On the exposed side portion of the aluminum foil substrate 100 and on the exposed side surface of the second electrically conductive material 105, two terminal electrodes 107 are respectively formed. Thereafter, a solder layer 108 is coated on each of the two terminal electrodes 107 as shown in FIG. 1E. The solder layer 108 may comprise tin or tin lead alloy. FIG. 1E shows a cross section of the aluminum electrolytic capacitor 10 in accordance with one embodiment of the present invention. The capacitor 10 can have terminal electrodes 107 without the assistance of a lead frame. Therefore, it has low ESR, reduced interface resistance, and low transmission impedance, and further offers superior high-frequency performance.

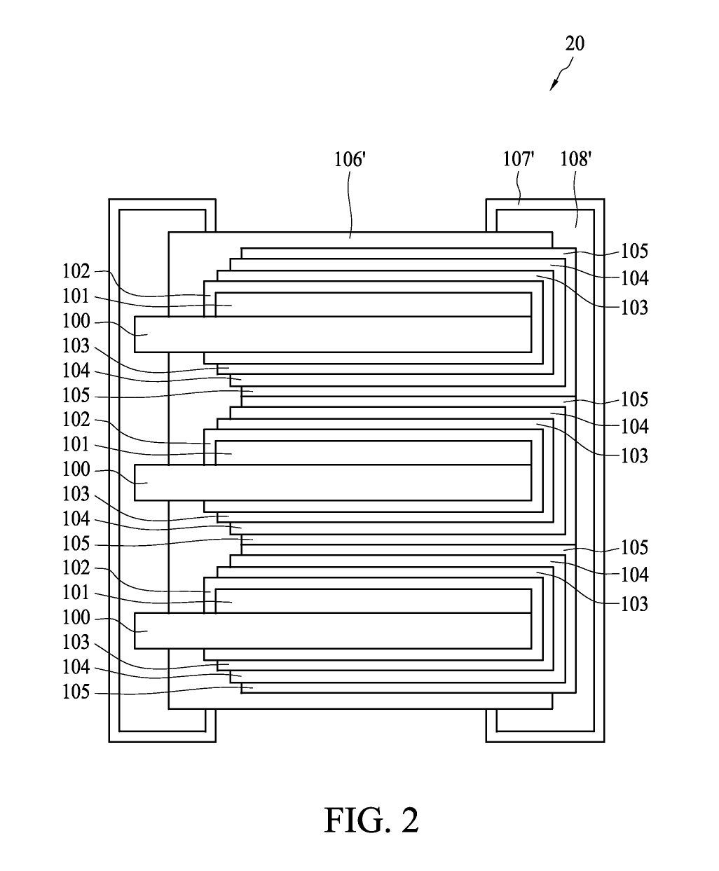

FIG. 2 is a cross-sectional view showing an aluminum electrolytic capacitor 20 including a stack of capacitor units according to one embodiment of the present invention. The aluminum electrolytic capacitor 20 is formed by vertically stacking three similar capacitor units, as shown in FIG. 1C. In the three vertically stacked capacitor units, the second electrically conductive material 105 of the lower capacitor unit supportively contacts the second electrically conductive material 105 of the upper capacitor unit. Similarly, a dielectric polymer material 106′ is formed to overlay the surfaces of three second electrically conductive materials 105 while the right side surfaces of the second electrically conductive materials 105 are exposed outside the dielectric polymer material 106′; meanwhile, the left side portions of the aluminum foil substrates 100 are also exposed outside the dielectric polymer material 106′. On the exposed side portions of the aluminum foil substrates 100 and on the exposed side surfaces of the second electrically conductive materials 105, terminal electrodes 107′ are respectively formed. Thereafter, a solder layer 108 is coated on each of the two terminal electrodes 107′. Consequently, such multi-capacitor units, which are stacked on each other and connected in parallel, can have greater capacitance and lower serial resistance.

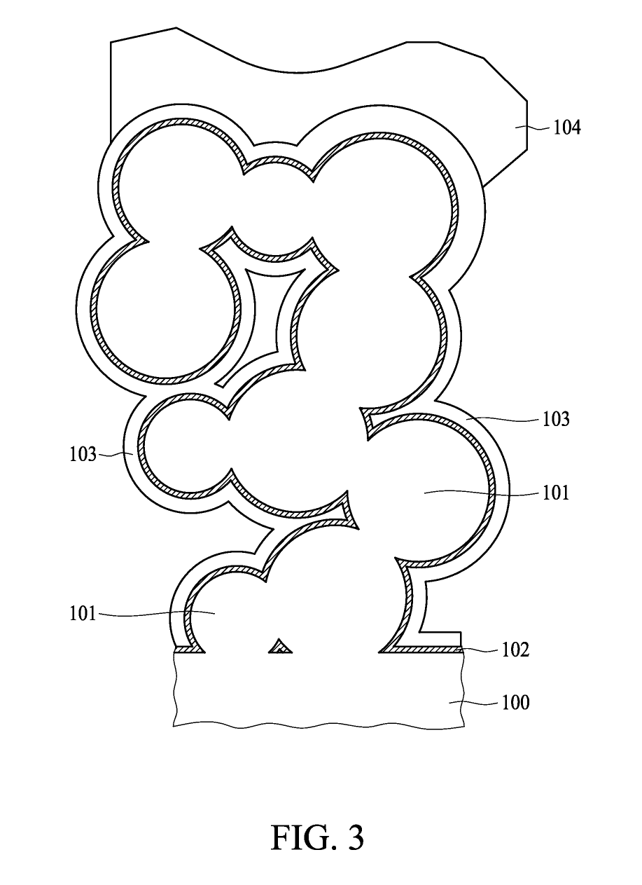

FIG. 3 is an enlarged view of an aluminum electrolytic capacitor according to one embodiment of the present invention. An insulating layer 102 of aluminum oxide is formed on the surface of the porous aluminum layer 101 and the surface of the aluminum foil substrate 100. Because the aluminum layer 101 is constituted by fine aluminum particles, pores exist between adjacent sintered-together aluminum particles. Thus, the insulating layer 102 may exist in the pores, on the surfaces of the aluminum particles. In addition, the electrically conductive polymer material 103 may also be formed on the surface of the insulating layer 102 in the pores between the aluminum particles.

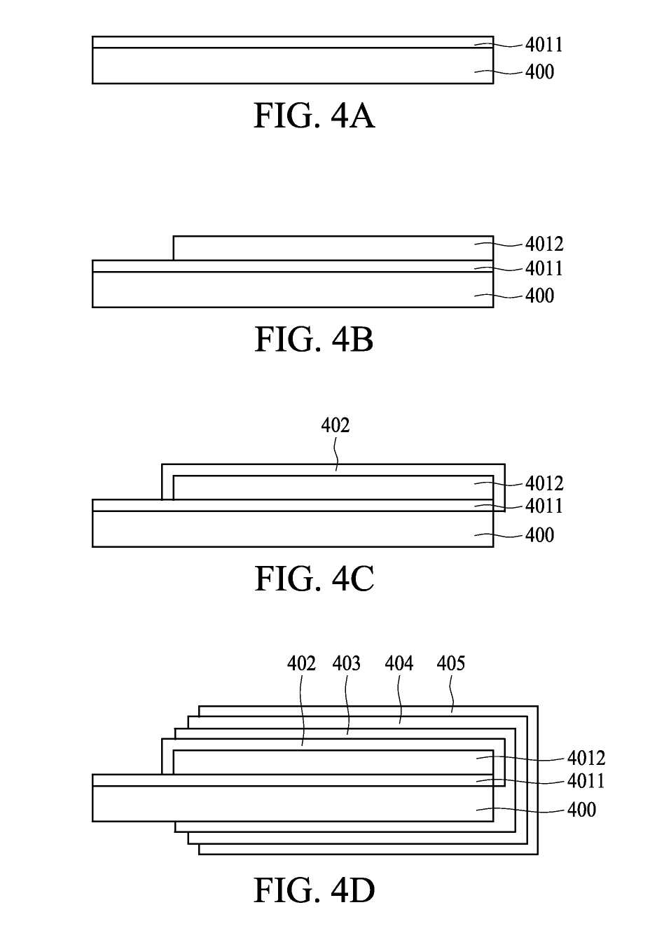

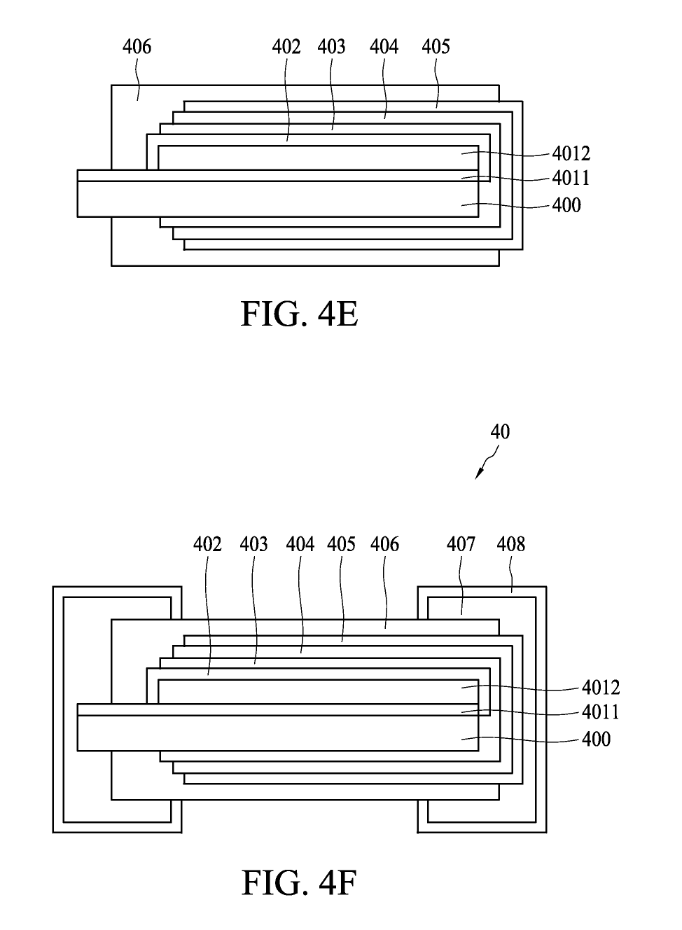

FIGS. 4A through 4E are cross-sectional views demonstrating the steps of a method of manufacturing an aluminum electrolytic capacitor according to one embodiment of the present invention. As shown in FIG. 4A, an insulating substrate 400 is provided. In one embodiment, the insulating substrate 400 is, preferably, an aluminum oxide, aluminum nitride, or glass substrate. A layer of aluminum powder is coated on a surface of the insulating substrate 400 by a printing method, and is then sintered at a temperature in a range of from 650 to 750 degrees Celsius to form a first aluminum layer 4011 with a dense structure. The first aluminum layer 4011 can be securely combined and electrically connected with the insulating substrate 400. Alternatively, instead of aluminum, other electrically conductive materials or other types of electrically conductive layers can be used as a replacement for the first aluminum layer 4011.

Another layer of aluminum powder is thereafter coated on a surface of the first aluminum layer 4011 by a printing method, and a sintering process is performed at a temperature in a range of from 550 to 650 degrees Celsius so as to form a porous second aluminum layer 4012, which is securely combined and electrically connected with the first aluminum layer 4011.

An insulating layer or dielectric layer 402 is next formed on a surface of the first aluminum layer 4011 and a surface of the second aluminum layer 4012, as shown in FIG. 4B. The insulating layer 402 on the left side surface of the first aluminum layer 4011 is then removed by, for example, a sandblasting method to expose a portion of the first aluminum layer 4011. Because the second aluminum layer 4012 is constituted by fine aluminum particles, pores exist between adjacent sintered-together aluminum particles. Thus, the insulating layer 402 also exists on the surfaces of the aluminum particles in the pores. Specifically, the coverage of the insulating layer 402 is not only as shown in FIG. 4B, but also extends on the walls defining the pores.

As shown in FIG. 4C, an electrically conductive polymer material 403, a first electrically conductive material 404, and a second electrically conductive material 405 are sequentially formed on the insulating layer 102. The electrically conductive polymer material 403 may include polyaniline, polypyrrole, or polythiophene, wherein polyaniline is preferred. For example, polyaniline can be obtained by polymerization of monomer aniline using an oxidant and a medium. The first electrically conductive material 404 can be carbon epoxy, carbon paste, or carbon ink. The second electrically conductive material 405 can be a silver paste. It should be noted that a suitable material is chosen as the electrically conductive polymer material 403; the capacitor may not necessarily include the first electrically conductive material 404 and a second electrically conductive material 405.

As illustrated in FIG. 4D, a dielectric polymer material 406 is formed to overlay the surface of the second electrically conductive material 405 while a side surface of the second electrically conductive material 405 is exposed outside the dielectric polymer material 406; meanwhile, the left side portion of the first aluminum layer 4011 is also exposed outside the dielectric polymer material 406.

Terminal electrodes 407 are formed respectively on the exposed left side portion of the first aluminum layer 4011 and the exposed side surface of the second electrically conductive material 405. A solder layer 408 is coated on each of the two terminal electrodes 407 as shown in FIG. 4E. FIG. 4E shows a cross section of the aluminum electrolytic capacitor 40 in accordance with one embodiment of the present invention. The capacitor 40 can have terminal electrodes 407 without the assistance of a lead frame. Therefore, it has low ESR, reduced interface resistance, and low transmission impedance, and further offers superior high-frequency performance.

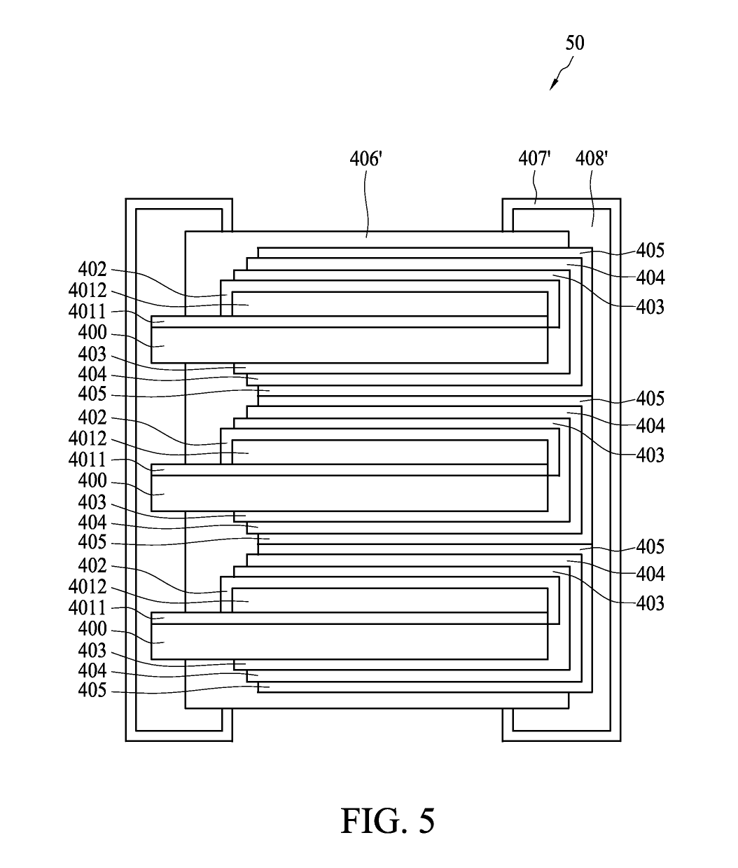

FIG. 5 is a cross-sectional view showing an aluminum electrolytic capacitor 50 including a stack of capacitor units according to one embodiment of the present invention. The aluminum electrolytic capacitor 50 is formed by vertically stacking three similar capacitor units, as shown in FIG. 4C. In the three vertically stacked capacitor units, the second electrically conductive material 405 of the lower capacitor unit supportively contacts the second electrically conductive material 105 of the upper capacitor unit. Similarly, a dielectric polymer material 406′ is formed to overlay the surfaces of three second electrically conductive materials 405 while the right side surfaces of the second electrically conductive materials 405 are exposed outside the dielectric polymer material 406′; meanwhile, the left side portions of the first aluminum layer 4011 are also exposed outside the dielectric polymer material 406′. On the exposed side portions of the insulating substrate 400 and on the exposed side surfaces of the second electrically conductive materials 405, terminal electrodes 407′ are respectively formed. Thereafter, a solder layer 408′ is coated on each of the two terminal electrodes 407′. Consequently, such multi-capacitor units, which are stacked on each other and connected in parallel, can have greater capacitance and lower serial resistance.

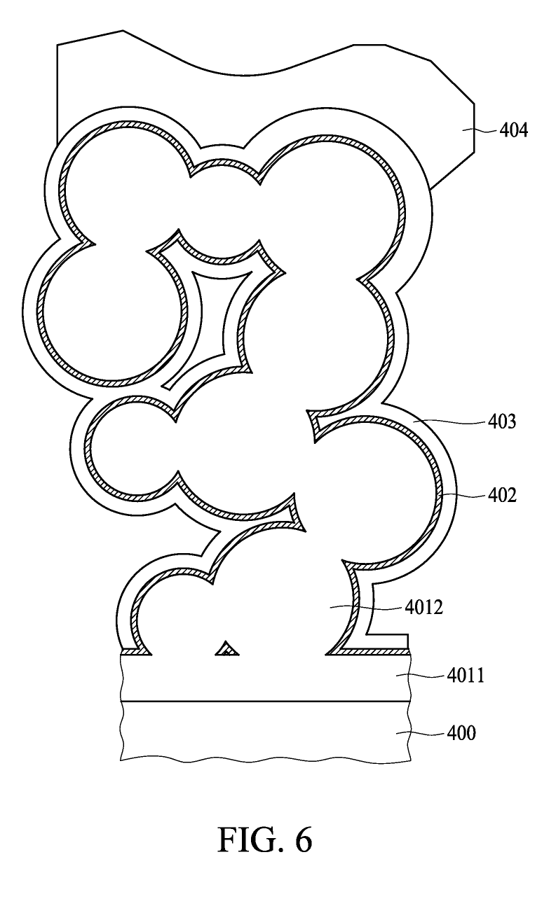

FIG. 6 is an enlarged view of an aluminum electrolytic capacitor according to one embodiment of the present invention. An insulating layer 402 of aluminum oxide is formed on the surface of the first aluminum layer 4011 and the surface of the porous second aluminum layer 4012. Because the second aluminum layer 4012 is constituted by fine aluminum particles, pores exist between adjacent sintered-together aluminum particles. The insulating layer 402 may exist in the pores, on the surfaces of the aluminum particles. In addition, the electrically conductive polymer material 403 may also be formed on the surface of the insulating layer 402 in the pores between the aluminum particles. The first aluminum layer 4011 is also constituted by fine aluminum particles. Since the first aluminum layer 4011 is sintered at a higher temperature, it has a denser structure.

The above-described embodiments of the present invention are intended to be illustrative only. Numerous alternative embodiments may be devised by person's skilled in the art without departing from the scope of the following claims.

What is claimed is:

1. An aluminum electrolytic capacitor, comprising:
an aluminum foil substrate;
a porous aluminum layer attached to the aluminum foil substrate;
an insulating layer formed on the porous aluminum layer; and
an electrically conductive polymer material overlaying the insulating layer.

2. The aluminum electrolytic capacitor of claim 1, further comprising an electrically conductive material overlaying the electrically conductive polymer material, a dielectric polymer material partially overlaying the electrically conductive material, and at least two terminal electrodes respectively electrically connecting the aluminum foil substrate and the electrically conductive material.

3. The aluminum electrolytic capacitor of claim 1, wherein the insulating layer comprises aluminum oxide.

4. The aluminum electrolytic capacitor of claim 3, wherein the aluminum oxide is in pores of the porous aluminum layer and on a surface of the aluminum foil substrate.

5. The aluminum electrolytic capacitor of claim 1, wherein the aluminum foil substrate comprises a plurality of cavities or dents formed on the surface of the aluminum foil substrate.

6. The aluminum electrolytic capacitor of claim 2, wherein each terminal electrode comprises a terminal electrode conductive body and a solder layer on the terminal electrode conductive body.

7. The aluminum electrolytic capacitor of claim 2, wherein the electrically conductive material comprises a first electrically conductive material on the electrically conductive polymer material and a second electrically conductive material on the first electrically conductive material, and the first electrically conductive material is carbon epoxy, carbon paste, or carbon ink, and the second electrically conductive material is silver paste.

8. The aluminum electrolytic capacitor of claim 1, wherein the electrically conductive polymer material is polyaniline, polypyrrole, or polythiophene.

9. An aluminum electrolytic capacitor, comprising:
an insulating substrate;
a first aluminum layer attached to the insulating substrate;
a porous second aluminum layer formed on the first aluminum layer;
an insulating layer formed on the first and second aluminum layers; and
an electrically conductive polymer material overlaying the insulating layer.

10. The aluminum electrolytic capacitor of claim 9, further comprising an electrically conductive material overlaying the electrically conductive polymer material, a dielectric polymer material partially overlaying the electrically conductive material, and at least two terminal electrodes respectively electrically connecting the first aluminum layer and the electrically conductive material.

11. The aluminum electrolytic capacitor of claim 9, wherein the insulating layer comprises aluminum oxide.

12. The aluminum electrolytic capacitor of claim 11, wherein the aluminum oxide is in pores of the second aluminum layer and on a surface of the first aluminum layer.

13. The aluminum electrolytic capacitor of claim 9, wherein the insulating substrate is an aluminum oxide, aluminum nitride, or glass substrate.

14. The aluminum electrolytic capacitor of claim 10, wherein each terminal electrode comprises a terminal electrode conductive body and a solder layer on the terminal electrode conductive body.

15. The aluminum electrolytic capacitor of claim 10, wherein the electrically conductive material comprises a first electrically conductive material on the electrically conductive polymer material and a second electrically conductive material on the first electrically conductive material, and the first electrically conductive material is carbon epoxy, carbon paste, or carbon ink, and the second electrically conductive material is silver paste.

16. The aluminum electrolytic capacitor of claim 9, wherein the electrically conductive polymer material is polyaniline, polypyrrole, or polythiophene.

17. An assembly of an aluminum electrolytic capacitor and a dielectric layer, comprising:
a substrate;
a porous aluminum layer attached to the substrate; and
an insulating layer formed on the porous aluminum layer.

18. The assembly of claim 17, wherein the substrate is an aluminum foil or aluminum oxide substrate with a rough surface.

19. The assembly of claim 17, wherein the insulating layer comprises aluminum oxide formed in pores of the porous aluminum layer and on a surface of the substrate.

20. The assembly of claim 17, further comprising a denser aluminum layer between the substrate and the porous aluminum layer.

21. An aluminum electrolytic capacitor, comprising:
an insulating substrate;
an electrically conductive layer formed on the insulating layer;
a porous aluminum layer formed on the electrically conductive layer;
an insulating layer formed on the electrically conductive layer and the porous aluminum layer; and
an electrically conductive polymer material overlying the insulating layer.

22. The aluminum electrolytic capacitor of claim 21, wherein the electrically conductive layer is a film of electrically conductive material.

23. The aluminum electrolytic capacitor of claim 22, wherein the electrically conductive material is aluminum.

24. The aluminum electrolytic capacitor of claim 21, further comprising an electrically conductive material overlaying the electrically conductive polymer material, a dielectric polymer material partially overlaying the electrically conductive material, and at least two terminal electrodes respectively electrically connecting the first aluminum layer and the electrically conductive material.

25. The aluminum electrolytic capacitor of claim 21, wherein the insulating layer comprises aluminum oxide.

26. The aluminum electrolytic capacitor of claim 21, wherein the insulating substrate is an aluminum oxide, aluminum nitride, or glass substrate.

27. The aluminum electrolytic capacitor of claim 24, wherein each terminal electrode comprises a terminal electrode conductive body and a solder layer on the terminal electrode conductive body.

28. The aluminum electrolytic capacitor of claim 24, wherein the electrically conductive material comprises a first electrically conductive material on the electrically conductive polymer material and a second electrically conductive material on the first electrically conductive material, and the first electrically conductive material is carbon epoxy, carbon paste, or carbon ink, and the second electrically conductive material is silver paste.

29. The aluminum electrolytic capacitor of claim 21, wherein the electrically conductive polymer material is polyaniline, polypyrrole, or polythiophene.
